(19) United States
(12) Patent Application Publication
(10) Pub. No.: US 2026/0154397 A1
(43) Pub. Date: Jun. 4, 2026

(54) REPOSITORY PACKAGE CACHING AND INSTALLATION

(71) Applicant: Snowflake Inc., Bozeman, MT (US)

(72) Inventors: Shixuan Fan, Sunnyvale, CA (US); Joseph Theodore Marylander, Seattle, WA (US); Bhanu Prakash, Kirkland, WA (US); Nitya Kumar Sharma, Bellevue, WA (US); Urjeet Shrestha, Seattle, WA (US); Ziliang Zhang, San Mateo, CA (US)

(21) Appl. No.: 18/965,721

(22) Filed: Dec. 2, 2024

(51) Int. Cl. G06F 21/53; G06F 21/57; H04L 67/5683

(52) U.S. Cl. CPC G06F 21/53; G06F 21/57; H04L 67/5683

(57) ABSTRACT

Methods, systems, and computer programs are presented for installing and executing a user function in a cloud data platform. The system receives a function for execution, determines the dependent packages required, and caches these packages in the cloud data platform. Upon receiving a request to execute the function, the system prepares an execution environment by loading the cached dependent packages. The function is then executed utilizing the cached packages. The caching mechanism optimizes package installations and reduces latency, ensuring efficient and secure function execution. The system includes a sandbox environment for determining dependencies with restricted network access, enhancing security during the installation process.

### TECHNICAL FIELD

The subject matter disclosed herein generally relates to methods, systems, and machine-readable storage media for executing user software in a cloud environment.

### BACKGROUND

Python is a popular language for data science and machine learning (ML). Python data science and ML applications can require different dependencies to function properly in a distributed database environment (e.g., virtual warehouses). One concern in implementing Python in a cloud data platform is dependency management. Dependencies include the software packages that are used by a given application that must be installed in order for the application to work as intended and avoid runtime errors.

One approach is to require end-users to upload and manage all the required packages. However, this can be problematic because a given program language's versioning (e.g., Python versioning) can be unorganized and difficult to manage. Managing all the dependencies in this approach can result in negative development user experience (e.g., extreme frustration encountered by end-users when installed software packages have dependencies on specific versions of other software packages). For instance, the dependency issue arises when several packages have dependencies on the same shared packages or libraries, but they depend on different and incompatible versions of the shared packages. If the shared package or library can only be installed in a single version, the user may need to address the problem by obtaining newer or older versions of the dependent packages. This, in turn, may break other dependencies and push the problem to another set of packages. Furthermore, requiring users to install and manage hundreds of packages is unsecured, cumbersome, and error-prone.

Existing solutions for managing Python libraries within data processing environments often fall short in several areas. Traditional methods may involve manually zipping and uploading folders containing the required libraries, which lack the structure and dependency management provided by proper Python packages. This approach can lead to inconsistencies and difficulties in maintaining the required libraries, especially when dealing with complex dependencies. Additionally, users may rely on predefined libraries provided by the platform, limiting their ability to incorporate external packages and sources.

### BRIEF DESCRIPTION OF THE DRAWINGS

Various appended drawings illustrate examples of the present disclosure and cannot be considered limiting its scope.

FIG. 1 is a flowchart of a method for preparing and executing User-Defined Functions (UDFs) in a cloud data platform, according to some examples.

FIG. 2 is a computing environment that includes a cloud data platform, according to some examples.

FIG. 3 is a block diagram illustrating components of a compute service manager of the cloud data platform, according to some examples.

FIG. 4 is a computing environment illustrating an example software architecture for executing a UDF by a process running on an execution node of the execution platform of FIG. 2, in accordance with some examples of the present disclosure.

FIG. 5 is a system for executing UDFs using an artifact repository service, according to some examples.

FIG. 6 is a flowchart of a method for creating a function in the cloud data platform, according to some examples.

FIG. 7 is a flowchart of a method for executing a function in the cloud data platform, according to some examples.

FIG. 8 is a diagram illustrating caching policies in the cloud data platform, according to some examples.

FIG. 9 is a flowchart of a method for installing and executing a user function in the cloud data platform, according to some examples.

FIG. 10 is a block diagram illustrating an example of a machine upon or by which one or more example process examples described herein may be implemented or controlled.

### DETAILED DESCRIPTION

Example methods, systems, and computer programs described herein are directed at installing and executing a user function in a cloud data platform. Examples merely typify possible variations. Unless explicitly stated otherwise, components and functions are optional and may be combined or subdivided, and operations may vary in sequence or be combined or subdivided. The following description provides numerous specific details to provide a thorough understanding of examples. However, it will be evident to one skilled in the art that the present subject matter may be practiced without these specific details.

The proposed solutions address the challenges of managing and installing Python libraries from external sources/repositories within a managed data processing environment. The solution allows users to specify the packages they need, which are then installed from various sources in a secure and governed manner.

Users are able to create a package specification that lists the required packages. This specification is run in a sandbox environment to determine dependencies without actual installation. This process, known as solving, ensures that the sandbox environment has restricted network access, only allowing connections to the specified remote endpoint.

Once the dependencies are determined, the solution implements a caching mechanism to optimize package installations and reduce the load on remote services. The caching mechanism includes shared and private caches for packages. The system determines when to cache packages, either at the point of determination or in a background thread. On-disk caching is also implemented to store packages locally on virtual machines (VMs) for faster access.

An artifact repository service is presented to manage package installations and apply governance policies. This service implements authentication mechanisms to connect to upstream repositories securely. Policies are applied to filter packages based on criteria such as Common Vulnerabilities and Exposures (CVE) scores and licenses. The service also provides a source for users to upload their packages, ensuring governance and security.

The presented solution provides techniques for providing a secure and efficient method for managing libraries, optimizing package installations, and ensuring compatibility between different package formats.

Expected benefits of implementing these techniques include improved efficiency in managing and installing libraries, reduced load on remote services, and enhanced security. Performance metrics, error reductions, and improvements in the function execution process are expected.

It is noted that some examples are described with reference to a Python environment, but the same principles may be used for any other programming language environment.

Some of the concepts used for the description of the solution are presented below.

Cache storage is a storage location within the cloud data platform where dependent packages are stored to optimize package installations and reduce the load on remote services.

Conda is a package management system that provides a base environment for installing and managing software packages, often used in data science and machine learning applications.

Dependencies are software packages required for the execution of a user-defined function.

An execution environment is a virtual machine or other isolated environment set up to execute a user-defined function, including necessary packages and dependencies.

A function is user-defined software that is specified for execution in the cloud data platform, including the required packages and input parameters.

Function creation is the process of preparing a user function for execution within the cloud data platform, including determining and caching the dependencies.

Global services (GS) is a global code layer that brokers requests to the execution platform, including components such as the authenticator, artifact repository metadata, and package metadata.

Package metadata is information related to the software packages available in the repository, including details about their versions and dependencies.

Private caching is a caching mechanism used for packages from private sources, ensuring that only the specific user can access the cached copies.

Public caching is a caching mechanism used for packages from public repositories, allowing several users of the cloud data platform to access the cached copies.

A repository service is a service responsible for managing the storage, retrieval, and governance of software packages, including connecting to upstream repositories and applying governance policies.

A sandbox environment is a secure, isolated environment with restricted network access used to determine package dependencies without performing the actual installation.

An upstream repository is an external repository from which packages are fetched when they are not available locally in the artifact repository service.

A User-defined function (UDF) is a function specified by the user for execution in the cloud data platform, including the required packages and input parameters.

UDF dependencies are the software packages required for the execution of a user-defined function.

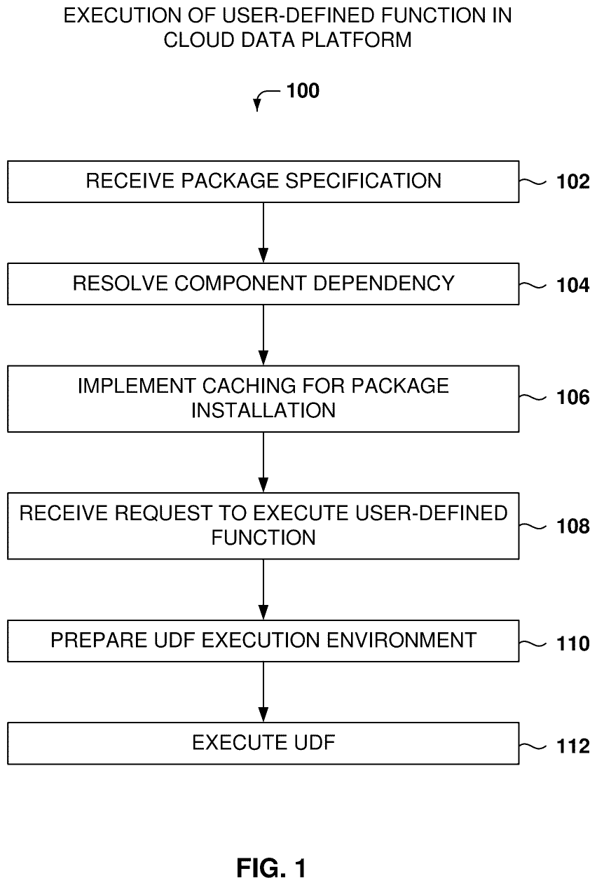

FIG. 1 is a flowchart of a method 100 for preparing and executing User-Defined Functions (UDFs) in a cloud data platform, according to some examples. While the various operations in this flowchart are presented and described sequentially, one of ordinary skill will appreciate that some or all of the operations may be executed in a different order, be combined or omitted, or be executed in parallel.

If a user wishes to install a package locally, it is possible today to accomplish this task with relative ease. For instance, utilizing a personal laptop, the user may execute the command “pip install,” which will retrieve the desired package from PyPI or an alternative repository, and then execute the software in its laptop.

However, executing a package in a cloud environment may be more difficult because the execution environment is not controlled by the user directly, and the user may have to use the services offered by the cloud provider, which determines how packages are installed and executed.

In the cloud platform, the user does not execute the “pip install” command. Instead, the customer specifies the desired packages for installation. Another aspect is the security measure implemented during the installation process, which is conducted in two separate steps. The first step involves the provision of a package specification, which is executed in a sandbox environment to determine the required dependencies.

In some implementations, the user is restricted to the packages provided by the cloud data platform, e.g., packages made available by Snowflake's Anaconda channel in a Conda environment. This means users cannot bring in packages from custom repositories with dependency resolution support, which could be PyPI or their own repositories that contain custom packages.

Further, adding a dependency to a repository has implications on reliability because if the repository goes down, the UDFs cannot run because they cannot get the packages. To solve this, in some examples, the cloud data platform caches the packages in an internal location so that it is not necessary to access external repositories during execution.

Further, the cloud data platform provides execution consistency by determining the repository package for multiple CPU architectures so that users get the same environment for each UDF invocation independent of the underlying architecture.

Further, the proposed solution guarantees secure dependency resolution and installation by using a sandboxed environment to determine package dependencies with limited network access. Further, the cloud data platform may block the execution of scripts during dependency resolution.

Additionally, during query execution, the installer is run in a sandboxed environment with no network access to prevent data exfiltration. Further, a safe sandbox execution environment is provided for running packages that come from external repositories.

FIG. 1 shows the process to execute a UDF in the cloud data platform. At operation 102, the cloud data platform receives a package specification. This package specification includes a list of required packages and their versions that the user-defined function will need to execute properly.

From operation 102, the method 100 flows to operation 104 for resolving component dependency. In this operation, the system analyzes the package specification to identify dependencies required for the specified packages. This process, known as solving, is performed in a sandbox environment with restricted network access, allowing connections only to the specified remote endpoint. In some examples, the sandbox environment does not have a writable file system, enhancing security. The dependencies are determined and listed without performing the actual installation.

For example, in a Python environment, during function creation, the user's Conda package requirement is analyzed to create a Conda environment in the cloud data platform. Afterward, a pip dry run is performed to solve for different CPU architectures and make sure the package versions match across the CPU architectures. As mentioned earlier, this process runs inside a secure sandbox. The solved dependencies for the function are stored so there is a consistent Python environment at execution time instead of trying to determine the dependencies at execution time, which may provide different results at different times. Additionally, the solved result is identified as a cache candidate, so these packages are cached internally.

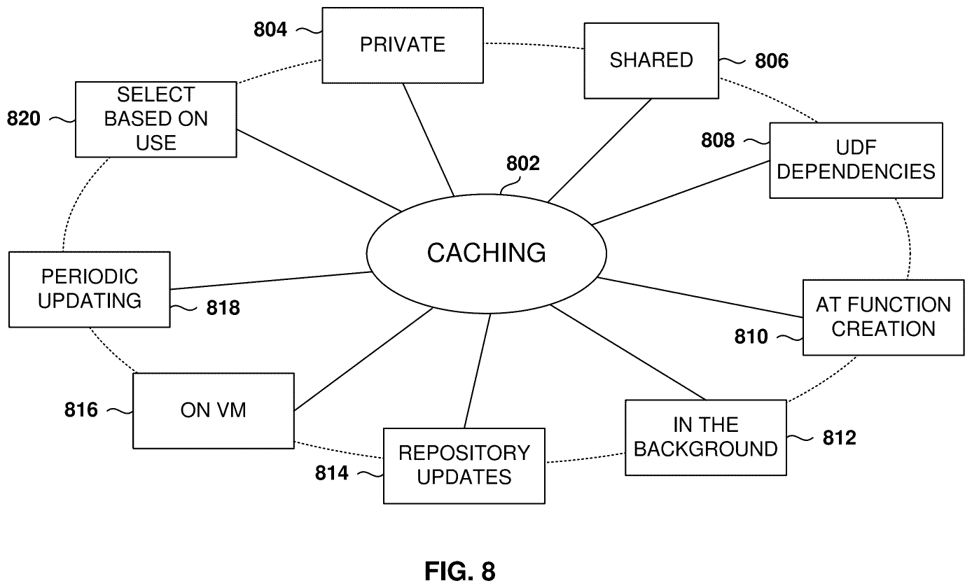

From operation 104, the method 100 flows to operation 106 for implementing caching for package installation. Once the dependencies are determined, the system implements a caching mechanism to optimize package installations and reduce the load on remote services. This involves creating shared and private caches for the determined dependencies, deciding when to cache the dependencies, either at the point of determination or in a background thread, and implementing on-disk caching to store dependencies locally on virtual machines (VMs) for faster access during function execution. Least Recently Used (LRU) policies are applied to manage the cache efficiently. More details about caching policies are described below with reference to FIG. 8.

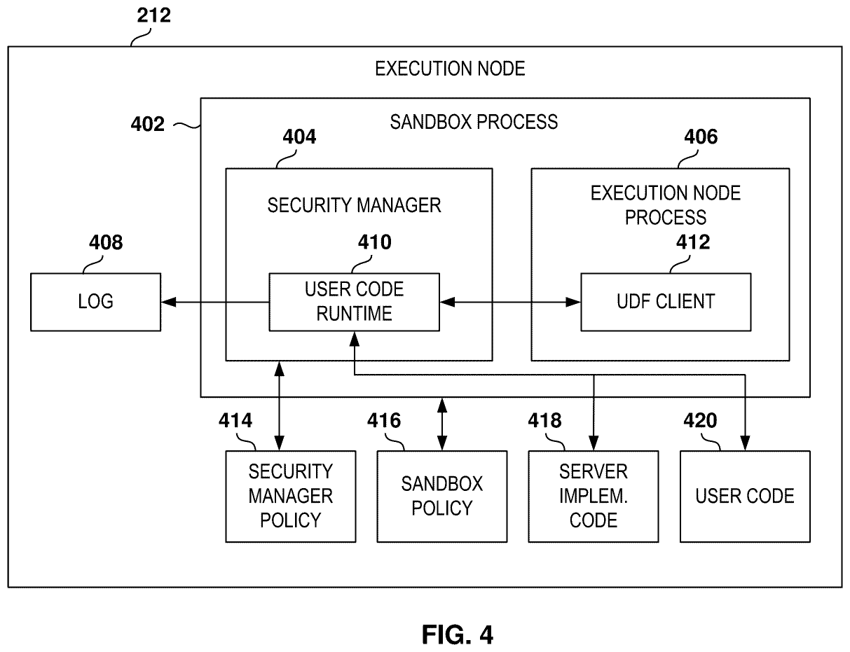

From operation 106, the method 100 flows to operation 108 for receiving a request to execute a user-defined function. In some examples, upon receiving the execution request, the cloud data platform sets up the function execution environment on a virtual machine (VM). This environment is isolated to ensure security and prevent interference with other processes. More details about the execution environment are provided below with reference to FIG. 4.

From operation 108, the method 100 flows to operation 110 for preparing the UDF execution environment. The system determines the required dependencies for the specified packages associated with the function. These dependencies were previously identified and cached during the function creation process. The system then downloads the required packages and dependencies from the cloud cache to the VM's disk.

If the same packages are needed again on the same VM, and the packages are in the on-disk cache, then the packages are accessed from the on-disk cache, reducing the need to download them again. The system verifies the integrity of the downloaded packages and dependencies before executing the function.

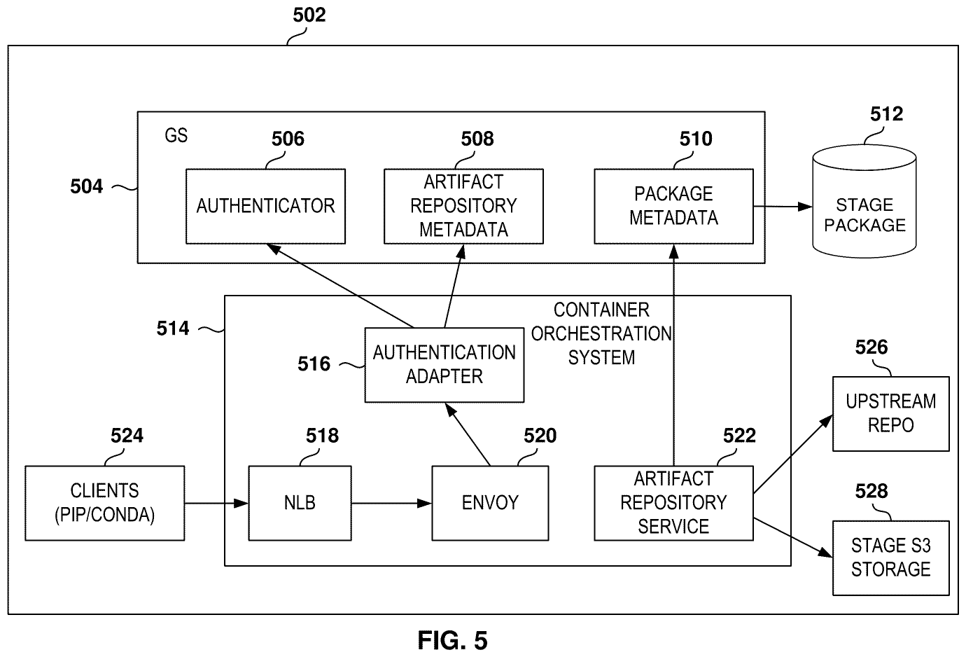

In some examples, an artifact repository service is implemented to manage package installations and apply governance policies. This includes building a repository service that exposes standard APIs (e.g., repository APIs provided by PyPi), implementing authentication mechanisms to connect to upstream repositories securely, applying policies to filter packages based on criteria such as CVE scores and licenses, and providing a source for users to upload their packages, ensuring governance and security. More details about the artifact repository service are described below with reference to FIG. 5.

From operation 110, the method 100 flows to operation 112 for executing the UDF. With the execution environment set up and the required packages and dependencies in place, the system executes the user-defined function. The function runs with the specified packages and dependencies, utilizing the cached components to speed up the process. Upon completion of the function execution, the system returns the results to the user.

In some examples, the packages can come from multiple package managers. For example, an installation may include Conda and Pypi packages together in the same environment, and during the execution of the function, the Conda packages are initially installed into the Python environment directory. Subsequently, the package is downloaded from the cached location, and a pip installation is performed inside a sandbox devoid of network access to ensure a secure installation. The environment is then mounted into the execution sandbox for the execution of the user-defined function. In some examples, the Python environment directory is also cached using a checksum of the packages.

The benefits provided by the techniques described herein include the following:
Ease of use: users provide the repository connection information and the list of packages desired, and the cloud data platform determines what packages to download and install to create the Python environment consistently.
Reliability: these techniques have limited exposure to the repository, and the UDF execution can tolerate availability issues in the repository.
Performance: the cloud data platform separates the download and installation of the packages, resulting in better parallelism to speed up the package installation.
Secure: the Python packages installed from the repository are solved and installed using a secure sandbox with limited file system and network access.

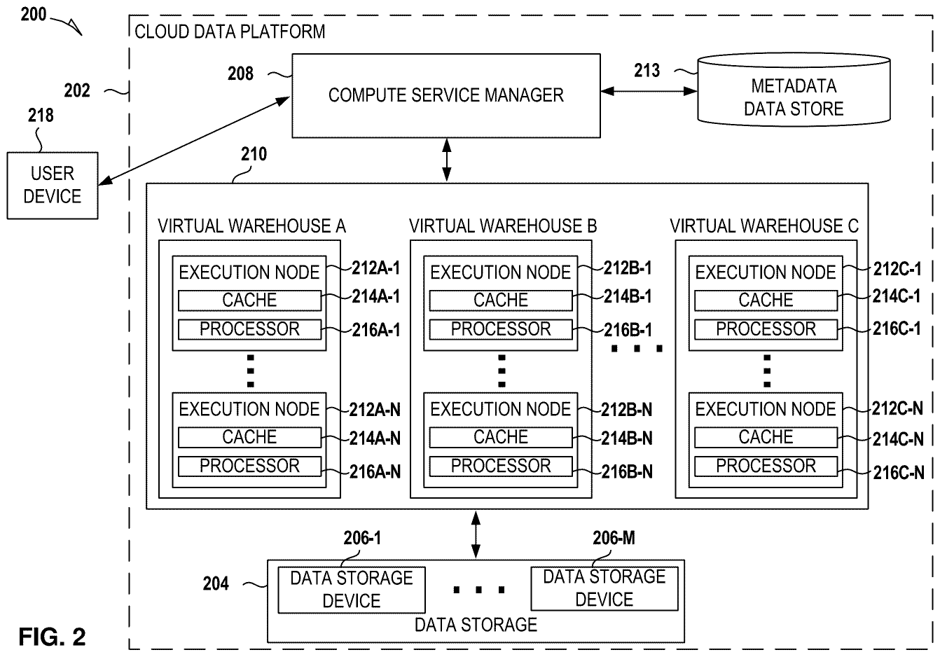

FIG. 2 illustrates a computing environment 200 that includes a cloud data platform 202 (CDF), according to some examples. To avoid obscuring the inventive subject matter with unnecessary detail, various functional components that are not germane to conveying an understanding of the inventive subject matter have been omitted from FIG. 2. However, a skilled artisan will readily recognize that various additional functional components may be included as part of the computing environment 200 to facilitate additional functionality that is not specifically described herein.

As shown, the cloud data platform 202 comprises a three-tier architecture: a compute service manager 208 coupled to a metadata data store 213, an execution platform 210, and data storage 204. The cloud data platform 202 hosts and provides data access, management, reporting, and analysis services to multiple client accounts. Administrative users can create and manage identities (e.g., users, roles, and groups) and use permissions to allow or deny access to the identities to resources and services. The cloud data platform 202 is used for reporting and analysis of integrated data from one or more disparate sources, including storage devices within the data storage 204. The data storage 204 comprises a plurality of computing machines and provides on-demand data storage resources to the cloud data platform 202.

The compute service manager 208 includes multiple services that coordinate and manage operations of the cloud data platform 202. For example, the compute service manager 208 is responsible for performing query optimization and compilation as well as managing clusters of compute nodes that perform query processing (also referred to as “virtual warehouses”). The compute service manager 208 can support any number of client accounts, such as end users providing data storage and retrieval requests, system administrators managing the systems and methods described herein, and other components/devices that interact with compute service manager 208.

The compute service manager 208 is also coupled to the metadata data store 213. The metadata data store 213 stores metadata pertaining to various functions and aspects associated with the cloud data platform 202 and its users. The metadata data store 213 also includes a summary of data stored in data storage 204 as well as data available from local caches. Additionally, the metadata data store 213 includes information regarding how data is organized in the data storage 204 and the local caches.

The compute service manager 208 is in communication with a user device 218. The user device 218 corresponds to a user of one of the multiple client accounts supported by the cloud data platform 202. In some implementations, the compute service manager 208 does not receive any direct communications from the user device 218 and only receives communications concerning jobs from a queue within the cloud data platform 202.

The compute service manager 208 is coupled to the metadata data store 213. The metadata data store 213 stores metadata pertaining to various functions and aspects associated with the cloud data platform 202 and its users. The metadata data store 213 also includes a summary of data stored in data storage 204 as well as data available from local caches. Additionally, the metadata data store 213 includes information regarding how data is organized in the data storage 204 and the local caches.

The compute service manager 208 is further coupled to the execution platform 210, which includes multiple virtual warehouses (computing clusters) that execute various data storage and data retrieval tasks. As an example, a set of processes on a compute node executes at least a portion of a query plan compiled by the compute service manager 208. As shown, the execution platform 210 includes virtual warehouse A, virtual warehouse B, and virtual warehouse C. Each virtual warehouse includes multiple execution nodes, each with a data cache and a processor. For example, as shown, virtual warehouse A includes execution nodes 212A-1 to 212A-N; execution node 212A-1 includes a cache 214A-1 and a processor 216A-1; and execution node 212A-N includes a cache 214A-N and a processor 216A-N. Similarly, in this example, virtual warehouse B includes execution nodes 212B-1 to 212B-N; execution node 212B-1 includes a cache 214B-1 and a processor 216B-1; and execution node 212B-N includes a cache 214B-N and a processor 216B-N. Additionally, virtual warehouse C includes execution nodes 212C-1 to 212C-N; execution node 212C-1 includes a cache 214C-1 and a processor 216C-1; and execution node 212C-N includes a cache 214C-N and a processor 216C-N.

Each execution node of the execution platform 210 is configured to process data storage and retrieval tasks. Hence, the virtual warehouses can execute multiple tasks in parallel utilizing the multiple execution nodes. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

In some examples, the execution nodes of the execution platform 210 are stateless with respect to the data the execution nodes are caching. That is, the execution nodes do not store or otherwise maintain state information about the execution node or the data being cached by a particular execution node, in these examples. Thus, in the event of an execution node failure, the failed node can be transparently replaced by another node. Since there is no state information associated with the failed execution node, the new (replacement) execution node can easily replace the failed node without concern for recreating a particular state.

The execution platform 210 may include any number of virtual warehouses. Additionally, the number of virtual warehouses in the execution platform 210 is dynamic, such that new virtual warehouses are created when additional processing and/or caching resources are needed. Similarly, existing virtual warehouses may be deleted when the resources associated with the virtual warehouse are no longer necessary.

Although each virtual warehouse shown in FIG. 2 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary. Additionally, although the execution nodes shown in the example of FIG. 2 each include a single data cache and a single processor, in other examples, execution nodes can contain any number of processors and any number of caches. Also, the caches may vary in size among the different execution nodes.

In some examples, the virtual warehouses of the execution platform 210 operate on the same data, but each virtual warehouse has its own execution nodes with independent processing and caching resources. This configuration allows requests on different virtual warehouses to be processed independently and with no interference between the requests. This independent processing, combined with the ability to add and remove virtual warehouses dynamically, supports the addition of new processing capacity for new users without impacting the performance observed by the existing users.

Although virtual warehouses A, B, and C are illustrated with an association with the same execution platform 210, the virtual warehouses may be implemented using multiple computing systems at multiple geographic locations. For example, virtual warehouse A can be implemented by a computing system at a first geographic location, while virtual warehouses B and C are implemented by another computing system at a second geographic location. In some examples, these different computing systems are cloud-based computing systems maintained by one or more different entities.

The execution platform 210 is coupled to data storage 204. The data storage 204 comprises multiple data storage devices 206-1 to 206-M. In some examples, the data storage devices 206-1 to 206-M are cloud-based storage devices located in one or more geographic locations. For example, the data storage devices 206-1 to 206-M may be part of a public cloud infrastructure or a private cloud infrastructure. The data storage devices 206-1 to 206-M may be hard disk drives (HDDs), solid state drives (SSDs), storage clusters, Amazon S3™ storage systems, or any other data storage technology. Additionally, the data storage 204 may include distributed file systems (e.g., Hadoop Distributed File Systems (HDFS)), object storage systems, and the like. In some examples, the storage devices 206-1 to 206-M are managed and provided by a third-party data storage platform (e.g., AWS®, Microsoft Azure Blob Storage®, or Google Cloud Storage®).

Each virtual warehouse can access any of the data storage devices 206-1 to 206-M shown in FIG. 2. Thus, the virtual warehouses are not necessarily assigned to a specific data storage device 206-1 to 206-M and, instead, can access data from any of the data storage devices 206-1 to 206-M within the data storage 204. Similarly, each of the execution nodes shown in FIG. 2 can access data from any of the data storage devices 206-1 to 206-M. In some examples, a particular virtual warehouse or a particular execution node may be temporarily assigned to a specific data storage device, but the virtual warehouse or execution node may later access data from any other data storage device.

In some examples, communication links between elements of the computing environment 200 are implemented via one or more data communication networks. These data communication networks may utilize any communication protocol and any type of communication medium. In some examples, the data communication networks are a combination of two or more data communication networks (or sub-networks) coupled to one another.

As shown in FIG. 2, the data storage devices 206-1 to 206-M are decoupled from the computing resources associated with the execution platform 210. This architecture supports dynamic changes to the cloud data platform 202 based on the changing data storage/retrieval needs as well as the changing needs of the users and systems. The support of dynamic changes allows the cloud data platform 202 to scale quickly in response to changing demands on the systems and components within the cloud data platform 202. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

During typical operation, the cloud data platform 202 processes multiple jobs determined by the compute service manager 208. These jobs are scheduled and managed by the compute service manager 208 to determine when and how to execute the job. For example, the compute service manager 208 may divide the job into multiple discrete tasks and may determine what data is needed to execute each of the multiple discrete tasks. The compute service manager 208 may assign each of the multiple discrete tasks to one or more execution nodes of the execution platform 210 to process the task. The compute service manager 208 may determine what data is needed to process a task and further determine which nodes within the execution platform 210 are best suited to process the task. Some nodes may have already cached the data needed to process the task and, therefore, be a good candidate for processing the task. Metadata stored in the metadata data store 213 assists the compute service manager 208 in determining which nodes in the execution platform 210 have already cached at least a portion of the data needed to process the task. One or more nodes in the execution platform 210 processes the task using data cached by the nodes and, if necessary, data retrieved from the data storage 204.

The compute service manager 208, metadata data store 213, execution platform 210, and data storage 204 are shown in FIG. 2 as individual discrete components. However, each of the compute service manager 208, metadata data store 213, execution platform 210, and data storage 204 may be implemented as a distributed system (e.g., distributed across multiple systems/platforms at multiple geographic locations). Additionally, each of the compute service manager 208, metadata data store 213, execution platform 210, and data storage 204 can be scaled up or down (independently of one another) depending on changes to the requests received and the changing needs of the cloud data platform 202. Thus, in the described examples, the cloud data platform 202 is dynamic and supports regular changes to meet the current data processing needs.

As shown in FIG. 2, the computing environment 200 separates the execution platform 210 from the data storage 204. In this arrangement, the processing resources and cache resources in the execution platform 210 operate independently of the data storage devices 206-1 to 206-M in the data storage 204. Thus, the computing resources and cache resources are not restricted to specific data storage devices 206-1 to 206-M. Instead, all computing resources and all cache resources may retrieve data from and store data to any of the data storage resources in the data storage 204.

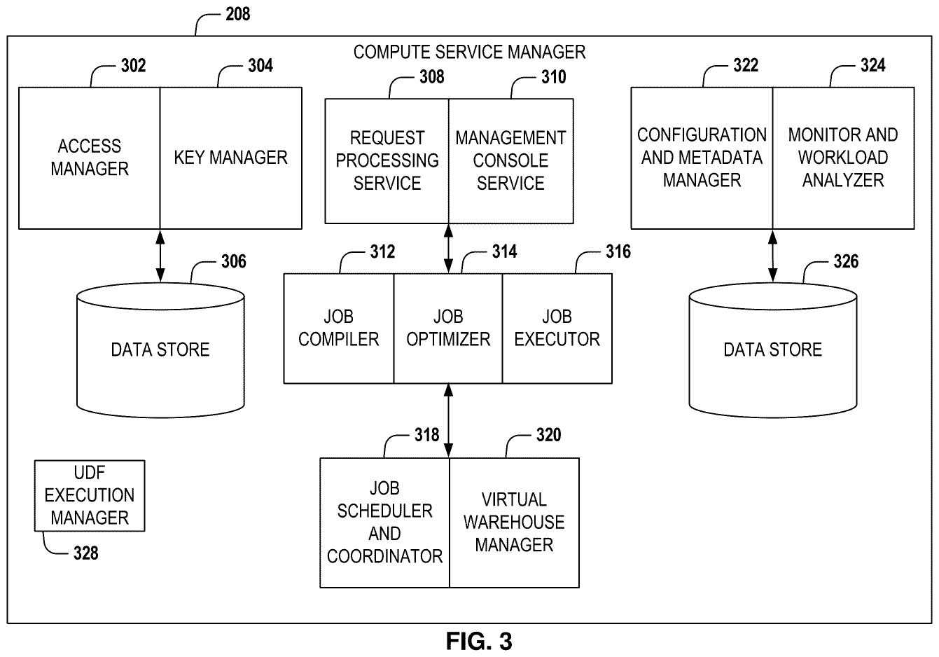

FIG. 3 is a block diagram illustrating components of the compute service manager 208, also referred to herein as Global Services (GS), of the cloud data platform, according to some examples. As shown in FIG. 3, the compute service manager 208 includes an access manager 302 and a key manager 304 coupled to a data store 306 that stores access information. Access manager 302 handles authentication and authorization tasks for the systems described herein. A UDF execution manager 328 manages operations related to UDF execution.

Key manager 304 manages the storage and authentication of keys used during authentication and authorization tasks. For example, access manager 302 and key manager 304 manage the keys used to access data stored in remote storage devices (e.g., data storage devices in data storage 306).

A request processing service 308 manages received data storage requests and data retrieval requests (e.g., jobs to be performed on database data). For example, the request processing service 308 may determine the data necessary to process a received query (e.g., a data storage request or data retrieval request). The data may be stored in a cache within the execution platform 210 or in a data storage device in data storage 306.

A management console service 310 supports access to various systems and processes by administrators and other system managers. Additionally, the management console service 310 may receive a request to execute a job and monitor the workload on the system.

The compute service manager 208 also includes a job compiler 312, a job optimizer 314, and a job executor 316. The job compiler 312 parses a job into multiple discrete tasks and generates the execution code for each of the multiple discrete tasks. The job optimizer 314 determines the best method to execute the multiple discrete tasks based on the data that needs to be processed. The job optimizer 314 also handles various data pruning operations and other data optimization techniques to improve the speed and efficiency of executing the job. The job executor 316 executes the execution code for jobs received from a queue or determined by the compute service manager 208.

A job scheduler and coordinator 318 sends received jobs to the appropriate services or systems for compilation, optimization, and dispatch to the execution platform 210. For example, jobs may be prioritized and processed in that prioritized order. In some examples, the job scheduler and coordinator 318 identifies or assigns particular nodes in the execution platform 210 to process particular tasks.

A virtual warehouse manager 320 manages the operation of multiple virtual warehouses implemented in the execution platform 210. As discussed below, each virtual warehouse includes multiple execution nodes that each include a cache and a processor.

Additionally, the compute service manager 208 includes a configuration and metadata manager 322, which manages the information related to the data stored in the remote data storage devices and in the local caches (e.g., the caches in execution platform 210). The configuration and metadata manager 322 uses the metadata to determine which storage units need to be accessed to retrieve data for processing a particular task or job. A monitor and workload analyzer 324 oversees processes performed by the compute service manager 208 and manages the distribution of tasks (e.g., workload) across the virtual warehouses and execution nodes in the execution platform 210. The monitor and workload analyzer 324 also redistributes tasks, as needed, based on changing workloads throughout the cloud data platform 202 and may further redistribute tasks based on a user (e.g., “external”) query workload that may also be processed by the execution platform 210. The configuration and metadata manager 322 and the monitor and workload analyzer 324 are coupled to a data store 326. Data store 326 in FIG. 3 represents any data repository or device within the cloud data platform 202. For example, data store 326 may represent caches in execution platform 210, storage devices in data storage 306, the metadata data store 213, or any other storage device or system.

FIG. 4 is a computing environment illustrating an example software architecture for executing a UDF by a process running on an execution node 212 of the execution platform 210 of FIG. 2, in accordance with some examples of the present disclosure.

As illustrated, the execution node 212 from the execution platform 210 includes an execution node process 406, which, in an example, is running on a processor 216A-1 and can also utilize memory from cache storage (or another memory device or storage). As mentioned herein, a “process” or “computing process” can refer to an instance of a computer program that is being executed by one or more threads by an execution node or execution platform.

In the illustrated example, the execution node process 406 is executing a UDF client 412. In some examples, the UDF client 412 is implemented to support UDFs written in a particular programming language such as JAVA and the like. In some examples, the UDF client 412 is implemented in a different programming language (e.g., C or C++) than the user code 420, which can further improve the security of the computing environment by using a different codebase (e.g., one with the same or fewer potential security exploits).

User code 420 may be provided as a package, e.g., in the form of a JAR (JAVA archive) file, which includes code for one or more UDFs. Server implementation code 418, in an example, is a JAR file that initiates a server that is responsible for receiving requests from the execution node process 406, assigning worker threads to execute user code, and returning the results, among other types of server tasks.

In some examples, an operation from a UDF (e.g., JAVA-based UDF) can be performed by a user code runtime 410 executing within a sandbox process 402. In some examples, the user code runtime 410 is implemented as a virtual machine, such as a JAVA virtual machine (JVM). Results of performing the operation, among other types of information or messages, can be stored in a log 408 for review and retrieval.

Security manager 404, in an example, can prevent the completion of an operation from a given UDF by throwing an exception (e.g., if the operation is not permitted). The security manager 404 can be implemented as a file with permissions that the user code runtime 410 is granted. The application (e.g., UDF executed by the user code runtime 410), therefore, can allow or disallow the operation based at least in part on the security manager policy 414. The sandbox process 402 can utilize a sandbox policy 416 to enforce a given security policy.

A sandbox process 402, in some examples, is a sub-process (or separate process) from the execution node process 406. The sandbox process 402, in an example, is a program that reduces the risk of security breaches by restricting the running environment of untrusted applications using security mechanisms such as namespaces and secure computing modes (e.g., using a system call filter to an executing process and its descendants, thus reducing the attack surface of the kernel of a given operating system). Moreover, in an example, the sandbox process 402 is a lightweight process in comparison to the execution node process 406 and is optimized (e.g., closely coupled to security mechanisms of a given operating system kernel) to process a database query securely within the sandbox environment.

The execution node 212 can be configured to instantiate a user code runtime to execute the code of the UDF and to create a runtime environment that allows the user's code to be executed. The user code runtime can include an access control process, including an access control list, where the access control list includes authorized hosts and access usage rights or other types of allow lists and blocklists with access control information. Instantiating a sandbox process can determine whether the UDF is permitted and instantiating the user code runtime as a child process of the sandbox process, the sandbox process configured to execute the at least one operation in a sandbox environment.

The sandbox process 402 can be understood as providing a constrained computing environment for a process (or processes) within the sandbox, where these constrained processes can be controlled and restricted to limit access to certain computing resources.

Although the above discussion of FIG. 4 describes components that are implemented using JAVA (e.g., an object-oriented programming language), it is appreciated that the other programming languages (e.g., interpreted programming languages) are supported by the computing environment. In some examples, Python is supported for implementing and executing UDFs in the computing environment. In this example, the user code runtime 410 can be replaced with a Python interpreter for executing operations from UDFs (e.g., written in Python) within the sandbox process 402.

FIG. 5 is a system 502 for executing UDFs using an artifact repository service, according to some examples. In existing solutions, if users want to use a package that is not available out of the box, they have to either wait for the software package vendor (e.g., Anaconda) to add it or try to use it through a stage upload mechanism that does not have dependency resolution or governance story.

The artifact repository service 522 presented herein allows users to bring in packages from external repositories to the cloud data platform and use them within the cloud data platform services, including their local development environments.

The system 502 comprises a Global Services (GS 504), which is a global code layer brokering requests to the execution platform (XP). The GS 504 comprises an authenticator 506, an artifact repository metadata 508, and a package metadata 510.

The authenticator 506 handles authentication tasks for the system, ensuring secure access to the artifact repository metadata 508 and package metadata 510. The artifact repository metadata 508 stores information related to the artifact repository, while the package metadata 510 contains details about the packages available in the repository. A stage package 512 database stores stages and packages and acts as cache storage.

A container orchestration system 514 (e.g., Kubernetes (K8s) apps cluster) is a cluster used to deploy and manage containerized applications. For example, Kubernetes is an open-source platform for automating the deployment, scaling, and operation of application containers, often used in cloud and hybrid environments.

The container orchestration system 514 includes an authentication adapter 516, an NLB 518 (Network Load Balancer), a proxy service like envoy 520, and an artifact repository service 522. The authentication adapter 516 facilitates secure communication between the GS 504 and the container orchestration system 514. The NLB 518 distributes incoming network traffic across multiple servers to ensure reliability and performance. The envoy 520 acts as a service proxy, managing communication between services within the cluster.

The artifact repository service 522 is responsible for managing package installations and applying governance policies. Instead of having users connect to an external source, the artifact repository service 522 provides an internal source where packages can be stored. The benefit of using this internal source is the capacity to apply various policies that pertain to the governance aspect. For example, if there is a request to exclude packages with a critical vulnerability (CV), the artifact repository service 522 can apply filtering. Requests may include excluding packages with a specific license or a particular CV score.

The artifact repository service 522 connects to upstream repositories 526 to fetch packages and stores them in a stage S3 storage 528 for caching and retrieval. Amazon Simple Storage Service (S3) is a cloud-based storage solution provided by AWS (Amazon Web Services). In other examples, other types of storage may be used to store repositories.

Clients 524 (e.g., PIP or Conda) interact with the container orchestration system 514 system to request package installations. The clients 524 send requests to the NLB 518, which forwards the requests to the envoy 520. The envoy 520 then communicates with the artifact repository service 522 to process the requests. The artifact repository service 522 retrieves the necessary packages from the upstream repository 526 or the stage S3 storage 528, depending on the availability and caching policies.

The authentication adapter 516 verifies the identity of clients and services before allowing access to the artifact repository metadata 508 and package metadata 510.

When packages are sourced from a third party or an external source, a proxy or intermediary layer is required, such as the artifact repository service 522. The artifact repository service 522 gathers information regarding the vulnerabilities of packages, including their CVE scores and related data. This information is subsequently utilized to prohibit certain packages for execution based on user-defined policies.

Furthermore, the artifact repository service 522 can be employed in non-managed environments, such as during the pip installation process. Thus, the user may utilize the artifact repository service 522 for local development because the artifact repository service 522 provides governance capabilities.

A user utilizing the artifact repository service 522 may engage via the standard PyPI API, given that the artifact repository service 522 provides access to standard APIs. The interactions will undergo interception and subsequent transmission to the GS 504 that builds the cache in a stage package 512 database. The artifact repository service 522 communicates with the GS 504 to determine whether a requested package is available in the cache. In the event the package is available, the process to execute the package continues. If the package is not available, the GS 504 will initiate retrieval of the necessary packages. Meanwhile, the artifact repository service 522 may obtain the package from the upstream repository 526 if the GS 504 does not have it in the cache.

The concept of upstream retrieval involves situations where a user provides personal resources or services. The artifact repository service 522 can incorporate upstream sources. Customers have the option to specify that a certain service should obtain its packages from one or more repositories (e.g., a personal repository). In instances where multiple repositories exist, the artifact repository service 522 determines the order of precedence among these sources, given that the same package might be present in several repositories.

The user may also specify priorities for repositories, and the artifact repository service 522 will look for packages in the repositories according to the given priority. Another prioritization method may be the order in which the repositories are defined, or the artifact repository service 522 may define heuristics for selecting the best repositories and prioritize accordingly. For example, a repository with the latest version of a package may be chosen first.

In some examples, the authenticator 506 facilitates authentication with the upstream repository through a two-step authentication process. The process begins when the customer accesses the service, followed by authentication with the upstream service. Upon successful authentication by the upstream service, a request is initiated for the available package versions associated with a specific package. The artifact repository service 522 retrieves the package versions and applies filters according to customer-defined policies, such as excluding packages with certain licenses or specific CVs. As a result, the user receives a restricted view of the available package versions.

An illustrative example involves a hypothetical scenario where package foo exists with ten different versions. When accessing information directly from PyPI or the upstream source, the artifact repository service 522 would typically indicate the availability of the ten versions of package foo for installation.

However, if a policy is applied to the repository service based on customer specifications, when the customer requests from the repository service a list of the available versions of package foo, the artifact repository service 522 queries the upstream repositories 526, which confirms the existence of ten versions. Upon discovering that some versions (e.g., versions 8 and 9) have elevated CV scores, those versions are subsequently excluded from the list provided to the customer. Consequently, fewer versions of package foo remain accessible. Despite this filtering process, the client application remains unaware of any modifications, as the interface presented remains consistent.

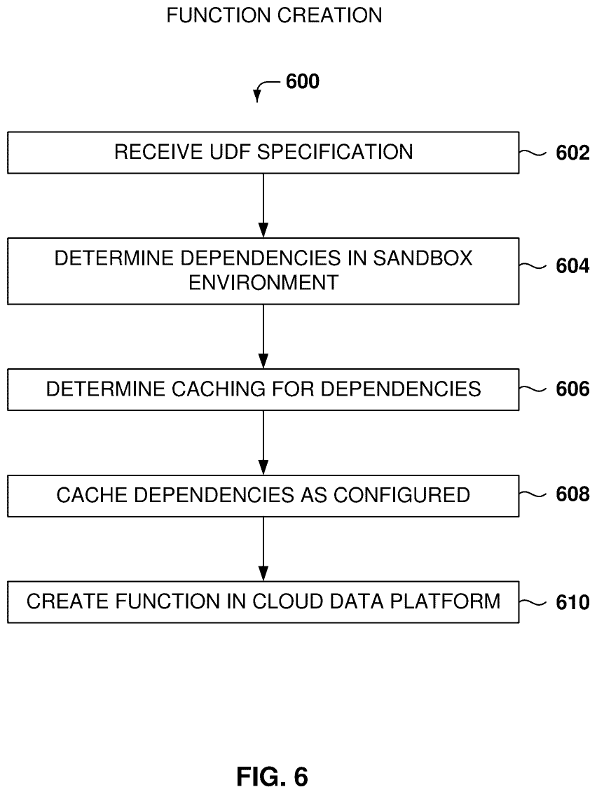

FIG. 6 is a flowchart of a method 600 for creating a function in the cloud data platform, according to some examples. While the various operations in this flowchart are presented and described sequentially, one of ordinary skill will appreciate that some or all of the operations may be executed in a different order, be combined or omitted, or be executed in parallel.

At operation 602, the system receives a User-Defined Function (UDF) specification. This specification includes a list of required packages and their versions that the UDF will need to execute properly. The package specification is submitted by the user to the cloud data platform.

From operation 602, the method 600 flows to operation 604 for determining dependencies in a sandbox environment. In this operation, the system analyzes the package specification to identify the dependencies required for the specified packages. This process, known as solving, is performed in a sandbox environment with restricted network access, allowing connections only to the specified remote endpoint. In some examples, the sandbox environment does not have a writable file system, enhancing security. The dependencies are determined and listed without performing the actual installation.

For example, the cloud data platform may analyze the user application to determine which packages, such as Python versions and libraries, are used by the user application, and generate a configuration file that specifies the identified packages, which may then be used to access the packages.

During function creation, the cloud data platform may solve dependencies for multiple architectures (e.g., ARM and x86). The user may explicitly indicate what is the preferred architecture.

There may be multiple execution environments, and the cloud data platform will work on making all environments available. For example, packages may be sourced from Anaconda, which operates its own package management system. However, Python may use wheels as the standardized format. The objective is to ensure the integration of the two systems. For example, there may be the Conda package and a wheel package provided by the customer. This flexibility allows customers to select certain packages from Conda and others from the wheel format or PyPI.

In some examples, installations from Conda used a base environment. Subsequently, this base environment is utilized to perform dependency resolution, considering the existing components of the base environment. This approach identifies what additional components are necessary to fulfill the user's requirements.

The abstraction of various components within the system allows the cloud data platform to operate on any architecture. If a package provides compatibility with both x86 and ARM architectures, the system will utilize both under the surface to ensure operation. For example, if a user-defined function (UDF) currently runs on ARM, it will execute with the corresponding package. Similarly, if it runs on x86, it will operate with that package, provided both versions are accessible. This approach contrasts with scenarios where the user explicitly selects a VM instance based solely on x86 architecture, in which case the responsibility of management falls on the user. In the current solution, such management is handled internally by the cloud data platform.

From operation 604, the method 600 flows to operation 606 for determining caching for dependencies. Once the dependencies are determined, the system implements a caching mechanism to optimize package installations and reduce the load on remote services. This involves creating shared and private caches for the determined dependencies, deciding when to cache the dependencies, either at the point of determination or in a background thread, and implementing on-disk caching to store dependencies locally on virtual machines (VMs) for faster access during function execution. In some examples, Least Recently Used (LRU) policies are applied to manage the cache efficiently and keep the packages that are used more often in the cache.

From operation 606, the method 600 flows to operation 608 for caching dependencies as configured. The system caches the dependencies based on the configuration determined in the previous operation. This may involve immediate caching at the point of determination or asynchronous caching in a background thread. The cached dependencies are stored in a manner that allows for efficient retrieval during function execution.

From operation 608, the method 600 flows to operation 610 for creating the function in the cloud data platform. With the dependencies determined and cached, the user function is created within the cloud data platform. The function is associated with the specified packages and dependencies, ensuring that the necessary components are available for execution.

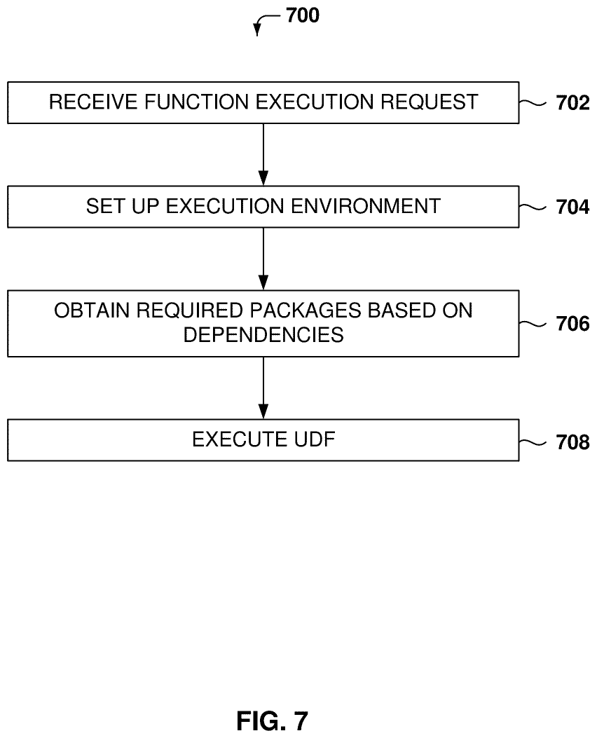

FIG. 7 is a flowchart of a method 700 for executing a function in the cloud data platform, according to some examples. While the various operations in this flowchart are presented and described sequentially, one of ordinary skill will appreciate that some or all of the operations may be executed in a different order, be combined or omitted, or be executed in parallel.

At operation 702, the system receives a function execution request. This request includes the function's identifier and any input parameters. The function execution request is submitted by the user to the cloud data platform.

From operation 702, the method 700 flows to operation 704 for setting up the execution environment. Upon receiving the execution request, the system sets up the function execution environment (e.g., on a virtual machine (VM)). This environment is isolated to ensure security and prevent interference with other processes.

From operation 704, the method 700 flows to operation 706 for obtaining required packages based on dependencies. The artifact repository service 522 determines the required dependencies for the specified packages associated with the function. These dependencies were previously identified and cached during the function creation process. The system then downloads the required packages and dependencies from the cache, if available, or other source to the VM's disk. If the packages previously loaded are needed again on the same VM, they are accessed from the on-disk cache, reducing the need to download them again.

From operation 706, the method 700 flows to operation 708 for executing the UDF. With the execution environment set up and the required packages and dependencies in place, the system executes the user-defined function. The function runs with the specified packages and dependencies, utilizing the cached components to speed up the process. Upon completion of the function execution, the system returns the results to the user and cleans up the execution environment.

The method for user function execution ensures that the required packages and dependencies are managed efficiently and securely within the cloud data platform environment. This process optimizes function execution, reduces latency, and maintains a secure and isolated execution environment.

FIG. 8 is a diagram illustrating caching policies in the cloud data platform, according to some examples. The diagram centers around the concept of caching 802, which is important for optimizing package installations and reducing the load on remote services. The caching mechanism includes several aspects, each represented by a different component in the diagram.

The caching service acts as a pull-through cache, which means the first time a package is accessed from an upstream repository, the package will be cached on the repository service, and a download link (e.g., pre-signed URL) is returned. When the code is going to be executed, the packages for the determined dependencies will be obtained either from a cached location or a remote repository (e.g., pypi.org).

Private caching 804 refers to caches used for packages from private sources. These caches ensure that only the specific user can access the cached copies, providing a secure way to manage and reuse packages that are not intended for public access.

Shared caching 806 is used for packages from public repositories or packages that are shared by users of the cloud data platform. This allows users of the cloud data platform to access the cached copies, reducing the load on remote services by reusing cached packages across multiple users.

UDF dependencies 808 are the dependencies required for User-Defined Functions (UDFs). As discussed above, these dependencies are determined during function creation and are cached to ensure that the necessary packages are readily available for function execution.

Caching may also be performed at function creation 810 by downloading and caching the packages after when the dependencies are determined during function creation instead of waiting until function execution. This approach may increase latency during function creation but ensures that the required packages are readily available for future use.

Caching in the background 812 refers to caching in the background. In some examples, a background job is created to download and cache the packages asynchronously. If a user needs the packages before they are cached, the system will still download them directly from the source. This method helps balance the load and reduce latency during function creation.

Caching for repository updates 814 involves updating the cache when the repository changes (e.g., a new version of a package is added). In some examples, the cloud data platform subscribes to updates from the remote repository feeds, such as RSS feeds from PyPI, which notify the system of new package versions. When the updates are received, the cloud data platform adds the new packages and, optionally, deletes older versions from the cache. This ensures that the cached dependency information remains accurate and up-to-date.

Caching on the VM 816 refers to VM on-disk caching, which stores packages locally on virtual machines (VMs) for faster access. When a function is executed, the required packages are downloaded from the cloud cache to the VM's disk. If the same packages are needed again on the same VM, they are accessed from the on-disk cache, reducing the need to download them again.

Periodic updating 818 involves updating the cache periodically to account for changing dependencies, as package versions and their dependencies may change over time. This ensures that the cached dependency information remains accurate and up-to-date.

In some examples, the cache is ephemeral due to continually changing dependencies. For example, a package may specify a dependency from package foo for certain versions of foo, e.g., version 3 or higher. Consequently, upon the release of version 4 of foo, this updated version is automatically selected as the version to use. Previous cached versions become outdated.

Select caching based on use 820 refers to caching based on usage patterns. The cloud data platform identifies the most frequently used packages and optimizes the cache for these packages. This may involve additional cache optimization and throttling strategies for the top packages to ensure efficient use of resources and reduce the load on remote services.

In some examples, caching policies are based on usage patterns and consider throttling costs. Upon identifying frequently accessed packages (e.g., typically, 5% of all available packages), optimization and throttling strategies should be explicitly applied to these packages. This approach avoids indiscriminate caching by recognizing that these frequently accessed packages may require multiple copies to prevent throttling due to repeated access to the same location. One objective is to ensure that cache construction is oriented toward usage patterns. In some examples, there may not be enough storage in the cache to store all the dependencies packages, so policies like Least Recently Used (LRU) are used to ensure efficient storage by keeping the packages currently used.

The advantages of incorporating caching include: the reduction of dependencies on third-party artifact providers as availability and latency remain resilient in the event of outages from external sources; and accelerated resolution and execution of UDFs. With package artifacts (e.g., wheels) stored in the cloud data platform, there will be no necessity to access the public internet for cache retrievals to download packages and their associated metadata.

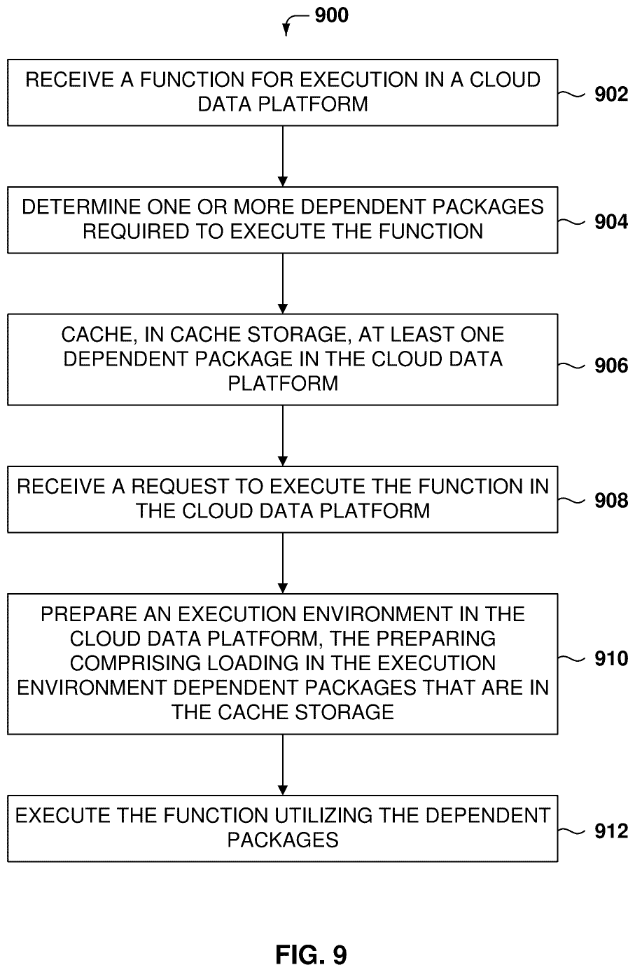

FIG. 9 is a flowchart of a method 900 for installing and executing a user function in the cloud data platform, according to some examples. While the various operations in this flowchart are presented and described sequentially, one of ordinary skill will appreciate that some or all of the operations may be executed in a different order, be combined or omitted, or be executed in parallel.

Operation 902 is for receiving a function for execution in a cloud data platform. This involves the cloud data platform accepting a user-defined function (UDF) that specifies the operations to be performed and the required input parameters.

From operation 902, the method 900 flows to operation 904 for determining one or more dependent packages required to execute the function. In this operation, the system analyzes the function to identify all necessary software packages and their dependencies. This process, known as solving, is performed in a sandbox environment with restricted network access, ensuring that only specified remote endpoints are accessible.

From operation 904, the method 900 flows to operation 906 for caching, in cache storage, at least one dependent package in the cloud data platform. Once the dependencies are determined, the system downloads the required packages from external repositories and stores them in the cloud data platform's cache storage. This caching mechanism optimizes package installations and reduces the time it takes to execute the UDF.

From operation 906, the method 900 flows to operation 908 for receiving a request to execute the function in the cloud data platform.

From operation 908, the method 900 flows to operation 910 for preparing an execution environment in the cloud data platform, the preparing comprising loading in the execution environment dependent packages that are in the cache storage.

From operation 910, the method 900 flows to operation 912 for executing the function utilizing the dependent packages. With the execution environment prepared and the necessary packages loaded, the system executes the user-defined function. The function runs with the specified packages and dependencies, utilizing the cached components to enhance performance and reduce latency. Upon completion of the function execution, the system returns the results to the user.

In view of the disclosure above, various examples are set forth below. It should be noted that one or more features of an example, taken in isolation or combination, should be considered within the disclosure of this application.

Example 1. A system comprising: one or more hardware processors; and a memory comprising instructions that, when executed by the one or more computer processors, cause the system to perform operations comprising: receiving a function for execution in a cloud data platform; determining one or more dependent packages required to execute the function; caching, in cache storage, at least one dependent package in the cloud data platform; receiving a request to execute the function in the cloud data platform; preparing an execution environment in the cloud data platform, the preparing comprising loading in the execution environment dependent packages that are in the cache storage; executing the function utilizing the dependent packages.

Example 2. The system of Example 1, wherein preparing the execution environment further comprises: obtaining one or more dependent packages unavailable in the cache storage from an external repository.

Example 3. The system of any one or more of Examples 1-2, wherein determining the one or more dependent packages is performed in a sandbox environment with restricted network access.

Example 4. The system of any one or more of Examples 1-3, wherein the caching further comprises: downloading from an external repository the dependent packages during function creation; and caching the dependent packages during function creation.

Example 5. The system of any one or more of Examples 1-4, wherein the caching further comprises: creating a background job to download and cache the dependent packages asynchronously with function creation.

Example 6. The system of any one or more of Examples 1-5, wherein the caching further comprises: monitoring an external repository storing at least one dependent package; determining that a new version of the at least one dependent package is available in the external repository; and updating the cache storage with the new version of the at least one dependent package.

Example 7. The system of any one or more of Examples 1-6, further comprising: caching, in the cache storage, dependencies of the function identified during function creation.

Example 8. The system of any one or more of Examples 1-7, wherein the caching further comprises: identifying most frequently used packages in the cloud data platform; and prioritizing the identified most frequently used packages for keeping in cache storage.

Example 9. The system of any one or more of Examples 1-8, wherein cache storage comprises storage in a database of the cloud data platform and storage in a virtual machine executing in the cloud data platform.

Example 10. The system of any one or more of Examples 1-9, wherein the cache storage is configured for storing private packages that are only available to a user and public packages that are available to a plurality of users in the cloud data platform.

Example 11. A computer-implemented method comprising: receiving a function for execution in a cloud data platform; determining one or more dependent packages required to execute the function; caching, in cache storage, at least one dependent package in the cloud data platform; receiving a request to execute the function in the cloud data platform; preparing an execution environment in the cloud data platform, the preparing comprising loading in the execution environment dependent packages that are in the cache storage; and executing the function utilizing the dependent packages.

Example 12. The method of Example 11, wherein preparing the execution environment further comprises: obtaining one or more dependent packages unavailable in the cache storage from an external repository.

Example 13. The method of any one or more of Examples 11-12, wherein determining the one or more dependent packages is performed in a sandbox environment with restricted network access.

Example 14. The method of any one or more of Examples 11-13, wherein the caching further comprises: downloading from an external repository the dependent packages during function creation; and caching the dependent packages during function creation.

Example 15. The method of any one or more of Examples 11-14, wherein the caching further comprises: creating a background job to download and cache the dependent packages asynchronously with function creation.

Example 16. A machine-storage medium including instructions that, when executed by a machine, cause the machine to perform operations comprising: receiving a function for execution in a cloud data platform; determining one or more dependent packages required to execute the function; caching, in cache storage, at least one dependent package in the cloud data platform; receiving a request to execute the function in the cloud data platform; preparing an execution environment in the cloud data platform, the preparing comprising loading in the execution environment dependent packages that are in the cache storage; and executing the function utilizing the dependent packages.

Example 17. The machine-storage medium of Example 16, wherein preparing the execution environment further comprises: obtaining one or more dependent packages unavailable in the cache storage from an external repository.

Example 18. The machine-storage medium of any one or more of Examples 16-17, wherein determining the one or more dependent packages is performed in a sandbox environment with restricted network access.

Example 19. The machine-storage medium of any one or more of Examples 16-18, wherein the caching further comprises: downloading from an external repository the dependent packages during function creation; and caching the dependent packages during function creation.

Example 20. The machine-storage medium of any one or more of Examples 16-19, wherein the caching further comprises: creating a background job to download and cache the dependent packages asynchronously with function creation.

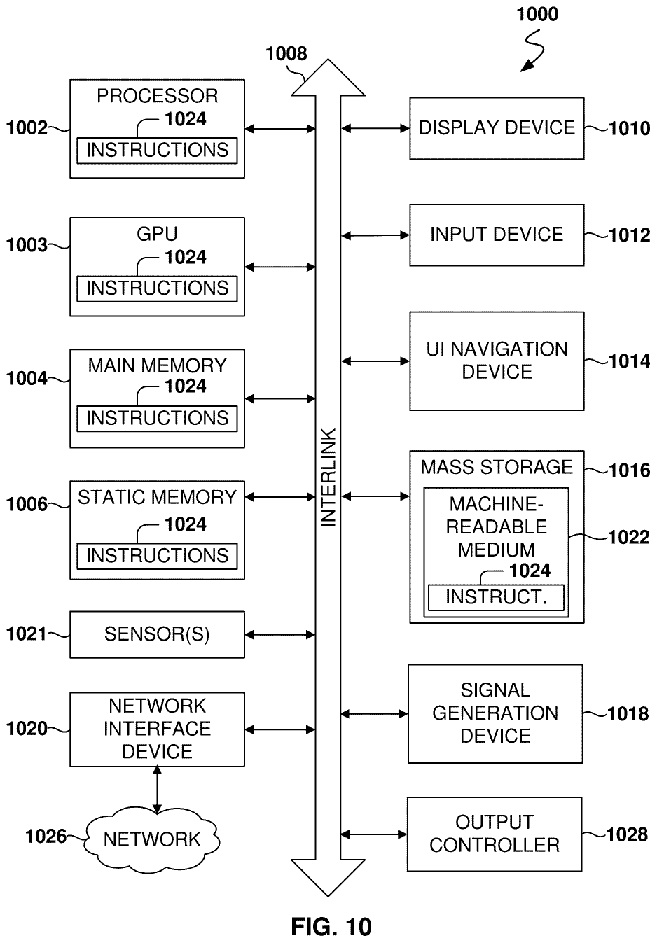

FIG. 10 is a block diagram illustrating an example of a machine 1000 upon or by which one or more example process examples described herein may be implemented or controlled. In alternative examples, the machine 1000 may operate as a standalone device or be connected (e.g., networked) to other machines. In a networked deployment, the machine 1000 may operate in the capacity of a server machine, a client machine, or both in server-client network environments. In an example, the machine 1000 may act as a peer machine in a peer-to-peer (P2P) (or other distributed) network environment. Further, while only a single machine 1000 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as recited herein, may include, or may operate by, logic, various components, or mechanisms. Circuitry is a collection of circuits implemented in tangible entities, including hardware (e.g., simple circuits, gates, logic). Circuitry membership may be flexible over time and underlying hardware variability. Circuitries include members that may, alone or in combination, perform specified operations when operating. In an example, the hardware of the circuitry may be immutably designed to carry out a specific operation (e.g., hardwired). In an example, the hardware of the circuitry may include variably connected physical components (e.g., execution units, transistors, simple circuits), including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other circuitry components when the device operates. In an example, any of the physical components may be used in more than one member of more than one circuitry. For example, under operation, execution units may be used in a first circuit of a first circuitry at one point in time and reused by a second circuit in the first circuitry or by a third circuit in a second circuitry at a different time.

The machine 1000 (e.g., computer system) may include a hardware processor 1002 (e.g., a central processing unit (CPU), a hardware processor core, or any combination thereof), a graphics processing unit (GPU 1003), a main memory 1004, and a static memory 1006, some or all of which may communicate with each other via an interlink 1008 (e.g., bus). The machine 1000 may further include a display device 1010, an alphanumeric input device 1012 (e.g., a keyboard), and a user interface (UI) navigation device 1014 (e.g., a mouse). In an example, the display device 1010, alphanumeric input device 1012, and UI navigation device 1014 may be a touch screen display. The machine 1000 may additionally include a mass storage device 1016 (e.g., drive unit), a signal generation device 1018 (e.g., a speaker), a network interface device 1020, and one or more sensors 1021, such as a Global Positioning System (GPS) sensor, compass, accelerometer, or another sensor. The machine 1000 may include an output controller 1028, such as a serial (e.g., universal serial bus (USB)), parallel, or other wired or wireless (e.g., infrared (IR), near field communication (NFC)) connection to communicate with or control one or more peripheral devices (e.g., a printer, card reader).

The processor 1002 refers to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor 1002 may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof.

The processor 1002 may further be a multi-core processor having two or more independent processors (sometimes referred to as “cores”) that may execute instructions contemporaneously. Multi-core processors contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. The processor 1002 may be emulated in software, running on a physical processor, as a virtual processor or virtual circuit. The virtual processor may behave like an independent processor but is implemented in software rather than hardware.

The mass storage device 1016 may include a machine-readable medium 1022 on which one or more sets of data structures or instructions 1024 (e.g., software) embodying or utilized by any of the techniques or functions described herein. The instructions 1024 may also reside, completely or at least partially, within the main memory 1004, within the static memory 1006, within the hardware processor 1002, or the GPU 1003 during execution thereof by the machine 1000. For example, one or any combination of the hardware processor 1002, the GPU 1003, the main memory 1004, the static memory 1006, or the mass storage device 1016 may constitute machine-readable media.

While the machine-readable medium 1022 is illustrated as a single medium, the term “machine-readable medium” may include a single medium or multiple media (e.g., a centralized or distributed database and associated caches and servers) configured to store one or more instructions 1024.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The term “machine-readable medium” may include any medium that is capable of storing, encoding, or carrying instructions 1024 for execution by the machine 1000 and that causes the machine 1000 to perform any one or more of the techniques of the present disclosure or that is capable of storing, encoding, or carrying data structures used by or associated with such instructions 1024. Non-limiting machine-readable medium examples may include solid-state memories and optical and magnetic media. For example, a massed machine-readable medium comprises a machine-readable medium 1022 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage medium,” “computer-storage medium,” and “device-storage medium” specifically exclude carrier waves, modulated data signals, and other such media.

The instructions 1024 may be transmitted or received over a communications network 1026 using a transmission medium via the network interface device 1020. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1024 for execution by the machine 1000, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented separately. These and other variations, modifications, additions, and improvements fall within the scope of the subject matter herein.

The examples illustrated herein are described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Additionally, as used in this disclosure, phrases of the form “at least one of an A, a B, or a C,” “at least one of A, B, and C,” and the like should be interpreted to select at least one from the group that comprises “A, B, and C.” Unless explicitly stated otherwise in connection with a particular instance, in this disclosure, this manner of phrasing does not mean “at least one of A, at least one of B, and at least one of C.” As used in this disclosure, the example “at least one of an A, a B, or a C” would cover any of the following selections: {A}, {B}, {C}, {A, B}, {A, C}, {B, C}, and {A, B, C}.

Moreover, plural instances may be provided for resources, operations, or structures described herein as a single instance. Additionally, boundaries between various resources, operations, modules, engines, and data stores are somewhat arbitrary, and particular operations are illustrated in the context of specific illustrative configurations. Other allocations of functionality are envisioned and may fall within the scope of various examples of the present disclosure. In general, structures and functionality are presented as separate resources in the example; configurations may be implemented as a combined structure or resource. Similarly, structures and functionality presented as a single resource may be implemented as separate resources. These and other variations, modifications, additions, and improvements fall within a scope of examples of the present disclosure as represented by the appended claims. Accordingly, the specification and drawings are to be regarded in an illustrative rather than a restrictive sense.

What is claimed is:

1. A system comprising:
one or more hardware processors; and
a memory comprising instructions that, when executed by the one or more computer processors, cause the system to perform operations comprising:
receiving a function for execution in a cloud data platform;
determining one or more dependent packages required to execute the function;
caching, in cache storage, at least one dependent package in the cloud data platform;
receiving a request to execute the function in the cloud data platform;
preparing an execution environment in the cloud data platform, the preparing comprising loading in the execution environment dependent packages that are in the cache storage; and
executing the function utilizing the dependent packages.

2. The system as recited in claim 1, wherein preparing the execution environment further comprises:
obtaining one or more dependent packages unavailable in the cache storage from an external repository.

3. The system as recited in claim 1, wherein determining the one or more dependent packages is performed in a sandbox environment with restricted network access.

4. The system as recited in claim 1, wherein the caching further comprises:
downloading from an external repository the dependent packages during function creation; and
caching the dependent packages during function creation.

5. The system as recited in claim 1, wherein the caching further comprises:
creating a background job to download and cache the dependent packages asynchronously with function creation.

6. The system as recited in claim 1, wherein the caching further comprises:
monitoring an external repository storing at least one dependent package;
determining that a new version of the at least one dependent package is available in the external repository; and
updating the cache storage with the new version of the at least one dependent package.

7. The system as recited in claim 1, further comprising:
caching, in the cache storage, dependencies of the function identified during function creation.

8. The system as recited in claim 1, wherein the caching further comprises:
identifying most frequently used packages in the cloud data platform; and
prioritizing the identified most frequently used packages for keeping in cache storage.

9. The system as recited in claim 1, wherein cache storage comprises storage in a database of the cloud data platform and storage in a virtual machine executing in the cloud data platform.

10. The system as recited in claim 1, wherein the cache storage is configured for storing private packages that are only available to a user and public packages that are available to a plurality of users in the cloud data platform.

11. The system as recited in claim 1, wherein the request specifies a processor architecture from a plurality of processor architectures, wherein preparing the execution environment further comprises:
loading the dependent packages according to the processor architecture specified in the request.

12. A computer-implemented method comprising:
receiving a function for execution in a cloud data platform;
determining one or more dependent packages required to execute the function;
caching, in cache storage, at least one dependent package in the cloud data platform;
receiving a request to execute the function in the cloud data platform;
preparing an execution environment in the cloud data platform, the preparing comprising loading in the execution environment dependent packages that are in the cache storage; and
executing the function utilizing the dependent packages.

13. The method as recited in claim 12, wherein preparing the execution environment further comprises:
obtaining one or more dependent packages unavailable in the cache storage from an external repository.

14. The method as recited in claim 12, wherein determining the one or more dependent packages is performed in a sandbox environment with restricted network access.

15. The method as recited in claim 12, wherein the caching further comprises:
downloading from an external repository the dependent packages during function creation; and
caching the dependent packages during function creation.

16. The method as recited in claim 12, wherein the caching further comprises:
creating a background job to download and cache the dependent packages asynchronously with function creation.

17. The method as recited in claim 12, wherein the caching further comprises:
monitoring an external repository storing at least one dependent package;
determining that a new version of the at least one dependent package is available in the external repository; and
updating the cache storage with the new version of the at least one dependent package.

18. The method as recited in claim 12, further comprising:
caching, in the cache storage, dependencies of the function identified during function creation.

19. The method as recited in claim 12, wherein the caching further comprises:
identifying most frequently used packages in the cloud data platform; and
prioritizing the identified most frequently used packages for keeping in cache storage.

20. The method as recited in claim 12, wherein the request specifies a processor architecture from a plurality of processor architectures, wherein preparing the execution environment further comprises:
loading the dependent packages according to the processor architecture specified in the request.

21. A machine-storage medium including instructions that, when executed by a machine, cause the machine to perform operations comprising:
receiving a function for execution in a cloud data platform;
determining one or more dependent packages required to execute the function;
caching, in cache storage, at least one dependent package in the cloud data platform;
receiving a request to execute the function in the cloud data platform;
preparing an execution environment in the cloud data platform, the preparing comprising loading in the execution environment dependent packages that are in the cache storage; and
executing the function utilizing the dependent packages.

22. The machine-storage medium as recited in claim 21, wherein preparing the execution environment further comprises:
obtaining one or more dependent packages unavailable in the cache storage from an external repository.

23. The machine-storage medium as recited in claim 21, wherein determining the one or more dependent packages is performed in a sandbox environment with restricted network access.

24. The machine-storage medium as recited in claim 21, wherein the caching further comprises:
downloading from an external repository the dependent packages during function creation; and
caching the dependent packages during function creation.

25. The machine-storage medium as recited in claim 21, wherein the caching further comprises:
creating a background job to download and cache the dependent packages asynchronously with function creation.

26. The machine-storage medium as recited in claim 21, wherein the caching further comprises:
monitoring an external repository storing at least one dependent package;
determining that a new version of the at least one dependent package is available in the external repository; and
updating the cache storage with the new version of the at least one dependent package.

27. The machine-storage medium as recited in claim 21, wherein the machine further performs operations comprising:
caching, in the cache storage, dependencies of the function identified during function creation.

28. The machine-storage medium as recited in claim 21, wherein the caching further comprises:
identifying most frequently used packages in the cloud data platform; and
prioritizing the identified most frequently used packages for keeping in cache storage.

29. The machine-storage medium as recited in claim 21, wherein cache storage comprises storage in a database of the cloud data platform and storage in a virtual machine executing in the cloud data platform.

30. The machine-storage medium as recited in claim 21, wherein the request specifies a processor architecture from a plurality of processor architectures, wherein preparing the execution environment further comprises:
loading the dependent packages according to the processor architecture specified in the request.
